(19) United States
(12) Patent Application Publication
(10) Pub. No.: US 2025/0348181 A1
(43) Pub. Date: Nov. 13, 2025

(54) AVIONICS GRAPHICAL TOUCH COUNTDOWN TIMER

(71) Applicant: Rockwell Collins, Inc., Cedar Rapids, IA (US)

(72) Inventor: Tyler J. Speidel, Cedar Rapids, IA (US)

(21) Appl. No.: 18/657,102

(22) Filed: May 7, 2024

(51) Int. Cl. G06F 3/0481; B64D 43/00; G06F 3/01; G06F 3/0484; G06F 3/0488

(52) U.S. Cl. CPC G06F 3/0481; B64D 43/00; G06F 3/016; G06F 3/0484; G06F 3/0488

(57) ABSTRACT

A system for controlling an aircraft is disclosed. The system may include a display configured for touchscreen interaction by a user and a controller communicatively coupled to the display. The controller may be configured to display a graphical user interface (GUI) and may include one or more processors configured to execute a set of program instructions. These instructions may be configured to cause the processors to display the GUI with a selectable graphical element representing a control function, detect a touch input on the selectable graphical element, display a sliding timer graphically integrated with the selectable graphical element indicating an elapsed time of the touch input relative to a predetermined activation threshold, and activate the control function when the elapsed time meets or exceeds the predetermined activation threshold.

### TECHNICAL FIELD

The present disclosure relates generally to avionics systems, and, particularly, to systems and methods for an interaction between pilots and touchscreen-based control interfaces.

### BACKGROUND

Touchscreen interfaces in aircraft cockpits have replaced many traditional mechanical controls, offering advanced functionality and streamlined cockpit aesthetics. However, the shift from tactile controls to touchscreens introduces challenges in accurately selecting and activating controls, particularly under conditions such as turbulence. Incorrectly selecting the wrong control item can have hazardous consequences.

Therefore, there is a need for a system and method that can enhance the reliability and accuracy of touchscreen interactions in aircraft control systems, ensuring that pilots can execute control functions safely and effectively despite the challenges posed by the cockpit environment.

### SUMMARY

A system for controlling an aircraft is disclosed in accordance with one or more illustrative embodiments of the present disclosure. In one illustrative embodiment, the system may include a display configured for touchscreen interaction by a user. In another illustrative embodiment, a controller may be communicatively coupled to the display and configured to display a graphical user interface (GUI). In another illustrative embodiment, the controller may include one or more processors configured to execute a set of program instructions stored in a memory. In another illustrative embodiment, the set of program instructions may be configured to cause the one or more processors to display the GUI comprising a selectable graphical element representing a control function. In another illustrative embodiment, the processors may detect a touch input on the selectable graphical element. In another illustrative embodiment, the processors may display a sliding timer graphically integrated with the selectable graphical element, where the sliding timer visually indicates an elapsed time of the touch input relative to a predetermined activation threshold. In another illustrative embodiment, the processors may activate the control function when the elapsed time of the touch input meets or exceeds the predetermined activation threshold.

In a further aspect, the sliding timer may include a graphical ring surrounding the selectable graphical element, and the graphical ring may be progressively filled or depleted to visually indicate the elapsed time of the touch input relative to the predetermined activation threshold. In another aspect, the sliding timer may include a straight graphical bar positioned adjacent to the selectable graphical element, and the straight graphical bar may be progressively filled or depleted to visually indicate the elapsed time. In another aspect, the GUI may further include a numerical representation positioned adjacent to the selectable graphical element, where the numerical representation is configured to progressively count up or down to numerically indicate the elapsed time. In another aspect, the controller may be further configured to remove the numerical representation from the GUI when the touch input is discontinued before the elapsed time meets the predetermined activation threshold. In another aspect, the controller may be configured to change a color of the sliding timer based on the elapsed time of the touch input to provide a visual indication of a remaining time until the control function is activated. In another aspect, the change of the color of the sliding timer may include the colors of red, orange, and green. In another aspect, the display may include an avionics display in an aircraft cockpit, and the control function may correspond to an aircraft system or operation. In another aspect, the system may include a vibrating mechanism coupled to the display, and the controller may be further configured to provide haptic feedback via the vibrating mechanism based on the elapsed time of the touch input relative to the predetermined activation threshold. In another aspect, at least one of an intensity or a frequency of the haptic feedback may be progressively increased or decreased based on the elapsed time of the touch input relative to the predetermined activation threshold.

A method for controlling an aircraft is disclosed in accordance with one or more illustrative embodiments of the present disclosure. In one illustrative embodiment, the method may include displaying a graphical user interface (GUI) on a display configured for touchscreen interaction by a user. In another illustrative embodiment, the GUI may include a selectable graphical element representing a control function. In another illustrative embodiment, the method may include detecting a touch input on the selectable graphical element. In another illustrative embodiment, the method may include displaying a sliding timer graphically integrated with the selectable graphical element, where the sliding timer visually indicates an elapsed time of the touch input relative to a predetermined activation threshold. In another illustrative embodiment, the method may include activating the control function when the elapsed time of the touch input meets or exceeds the predetermined activation threshold.

In a further aspect, the sliding timer may include a graphical ring surrounding the selectable graphical element, and the graphical ring may be progressively filled or depleted to visually indicate the elapsed time of the touch input relative to the predetermined activation threshold. In another aspect, the sliding timer may include a straight graphical bar positioned adjacent to the selectable graphical element, and the straight graphical bar may be progressively filled or depleted to visually indicate the elapsed time of the touch input relative to the predetermined activation threshold. In another aspect, the method may further include displaying a numerical representation positioned adjacent to the selectable graphical element, where the numerical representation is configured to progressively count up or down to numerically indicate the elapsed time of the touch input relative to the predetermined activation threshold. In another aspect, the method may further include removing the numerical representation from the GUI when the touch input is discontinued before the elapsed time meets the predetermined activation threshold. In another aspect, the method may include changing a color of the sliding timer based on the elapsed time of the touch input to provide a visual indication of a remaining time until the control function is activated. In another aspect, the changing of the color of the sliding timer may include the colors of red, orange, and green. In another aspect, the display may include an avionics display in an aircraft cockpit, and the control function may correspond to an aircraft system or operation. In another aspect, the method may further include providing haptic feedback via a vibrating mechanism coupled to the display, based on the elapsed time of the touch input relative to the predetermined activation threshold. In another aspect, at least one of an intensity or a frequency of the haptic feedback may be progressively increased or decreased based on the elapsed time of the touch input relative to the predetermined activation threshold.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a simplified block diagram of an aircraft including the system, in accordance with one or more embodiments of the present disclosure.

FIG. 1B is an aircraft including the system, in accordance with one or more embodiments of the present disclosure.

FIG. 2 is a flow diagram illustrating steps performed in a method, in accordance with one or more embodiments of the present disclosure

FIG. 3 is a time series set of views of a user input and of the GUI, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

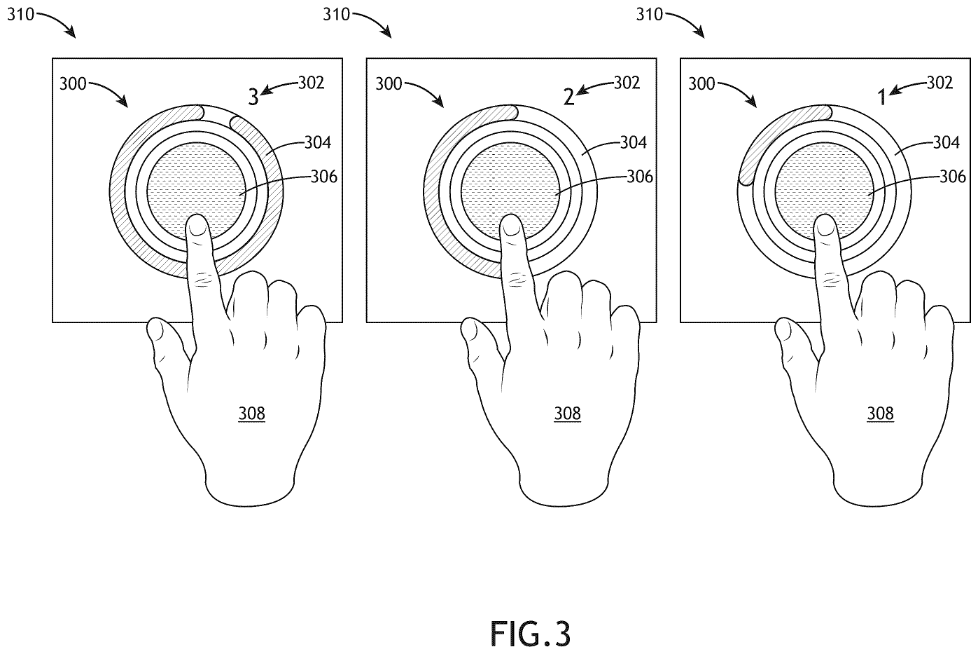

Broadly speaking, embodiments of the concepts disclosed herein are directed to a system and method for displaying and selecting a graphical element. The GUI may be displayed as an interface for user interaction within an aircraft's cockpit, as shown in FIG. 3. The GUI may be designed to provide a user, such as a pilot or co-pilot, with access to various control functions of the aircraft through touch-based inputs. The GUI may incorporate a variety of visual cues and time-based interactive elements to facilitate intuitive operation and minimize the potential for inadvertent activations, which may increase integrity under conditions of high turbulence or other stressful flying scenarios.

The graphical elements may also be in a particularly compact configuration and provide one or more ways to inform a user of its imminent activation. For example, one or more of a depleting/filling progress bar, numerical countdown, changing color, and/or haptic feedback may be used to inform the user the graphical element is about to be activated or the like. For instance, all of these may be used simultaneously.

Further, combinations of other feedback mechanisms may improve the pilot's understanding of the timing of the functions, such as increasing haptic feedback frequencies and intensity, changing colors over time, and numerical representations. The combination may provide surety of feedback not necessarily achievable by a single feedback mechanism alone.

Referring to FIG. 3, a graphical user interface (GUI) 310 is disclosed. The GUI 310 may correspond to a graphical representation of selectable functionality of an aircraft. The GUI 310 may display a selectable graphical element (e.g., button) in a compact area, providing space for other GUI elements.

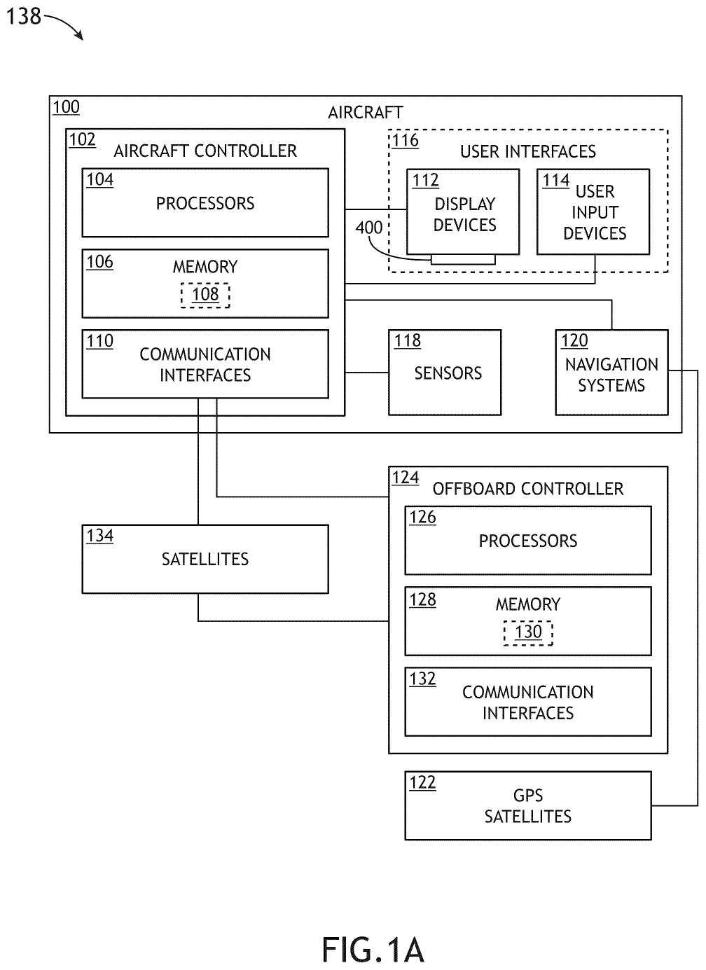

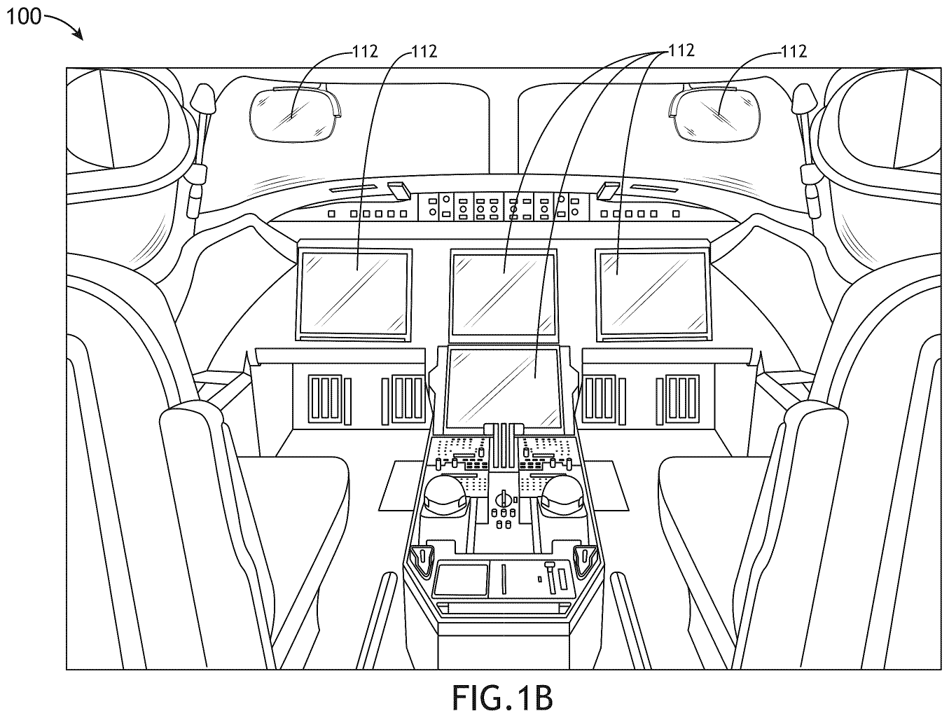

Referring now to FIGS. 1A-1B, an aircraft including a system 138 is illustrated, in accordance with one or more embodiments of the present disclosure.

Referring now to FIG. 1A, the aircraft 100 may include an aircraft controller 102 (e.g., on-board/run-time controller). The aircraft controller 102 may include one or more processors 104, memory 106 configured to store one or more program instructions 108, and/or one or more communication interfaces 110.

The aircraft 100 may include an avionics environment such as, but not limited to, a cockpit. The aircraft controller 102 may be coupled (e.g., physically, electrically, and/or communicatively) to one or more display devices 112. The one or more display devices 112 may be configured to display three-dimensional images and/or two-dimensional images. Referring now to FIG. 1B, the avionics environment (e.g., the cockpit) may include any number of display devices 112 (e.g., one, two, three, or more displays) such as, but not limited to, one or more head-down displays (HDDs) 112, one or more head-up displays (HUDs) 112, one or more multi-function displays (MFDs), one or more adaptive flight displays (AFDs) 112, one or more primary flight displays (PFDs) 112, or the like. The one or more display devices 112 may be employed to present flight data including, but not limited to, situational awareness data and/or flight queue data to a pilot or other crew member. For example, the situational awareness data may be based on, but is not limited to, aircraft performance parameters, aircraft performance parameter predictions, sensor readings, alerts, or the like.

Referring again to FIG. 1A, the aircraft controller 102 may be coupled (e.g., physically, electrically, and/or communicatively) to one or more user input devices 114. The one or more display devices 112 may be coupled to the one or more user input devices 114. For example, the one or more display devices 112 may be coupled to the one or more user input devices 114 by a transmission medium that may include wireline and/or wireless portions. The one or more display devices 112 may include and/or be configured to interact with one or more user input devices 114.

The one or more display devices 112 and the one or more user input devices 114 may be standalone components within the aircraft 100. It is noted herein, however, that the one or more display devices 112 and the one or more user input devices 114 may be integrated within one or more common user interfaces 116.

Where the one or more display devices 112 and the one or more user input devices 114 are housed within the one or more common user interfaces 116, the aircraft controller 102, one or more offboard controllers 124, and/or the one or more common user interfaces 116 may be standalone components. It is noted herein, however, that the aircraft controller 102, the one or more offboard controllers 124, and/or the one or more common user interfaces 116 may be integrated within one or more common housings or chassis.

The aircraft controller 102 may be coupled (e.g., physically, electrically, and/or communicatively) to and configured to receive data from one or more aircraft sensors 118. The one or more aircraft sensors 118 may be configured to sense a particular condition(s) external or internal to the aircraft 100 and/or within the aircraft 100. The one or more aircraft sensors 118 may be configured to output data associated with particular sensed condition(s) to one or more components/systems onboard the aircraft 100. Generally, the one or more aircraft sensors 118 may include, but are not limited to, one or more inertial measurement units, one or more airspeed sensors, one or more radio altimeters, one or more flight dynamic sensors (e.g., sensors configured to sense pitch, bank, roll, heading, and/or yaw), one or more weather radars, one or more air temperature sensors, one or more surveillance sensors, one or more air pressure sensors, one or more engine sensors, and/or one or more optical sensors (e.g., one or more cameras configured to acquire images in an electromagnetic spectrum range including, but not limited to, the visible light spectrum range, the infrared spectrum range, the ultraviolet spectrum range, or any other spectrum range known in the art).

The aircraft controller 102 may be coupled (e.g., physically, electrically, and/or communicatively) to and configured to receive data from one or more navigational systems 120. The one or more navigational systems 120 may be coupled (e.g., physically, electrically, and/or communicatively) to and in communication with one or more GPS satellites 122, which may provide vehicular location data (e.g., aircraft location data) to one or more components/systems of the aircraft 100. For example, the one or more navigational systems 120 may be implemented as a global navigation satellite system (GNSS) device, and the one or more GPS satellites 122 may be implemented as GNSS satellites. The one or more navigational systems 120 may include a GPS receiver and a processor. For example, the one or more navigational systems 120 may receive or calculate location data from a sufficient number (e.g., at least four) of GPS satellites 122 in view of the aircraft 100 such that a GPS solution may be calculated.

It is noted herein the one or more aircraft sensors 118 may operate as a navigation device 120, being configured to sense any of various flight conditions or aircraft conditions typically used by aircraft and output navigation data (e.g., aircraft location data, aircraft orientation data, aircraft direction data, aircraft speed data, and/or aircraft acceleration data). For example, the various flight conditions or aircraft conditions may include altitude, aircraft location (e.g., relative to the earth), aircraft orientation (e.g., relative to the earth), aircraft speed, aircraft acceleration, aircraft trajectory, aircraft pitch, aircraft bank, aircraft roll, aircraft yaw, aircraft heading, air temperature, and/or air pressure. By way of another example, the one or more aircraft sensors 118 may provide aircraft location data and aircraft orientation data, respectively, to the one or more processors 104, 126.

The aircraft controller 102 of the aircraft 100 may be coupled (e.g., physically, electrically, and/or communicatively) to one or more offboard controllers 124.

The one or more offboard controllers 124 may include one or more processors 126, memory 128 configured to store one or more programs instructions 130 and/or one or more communication interfaces 132.

The aircraft controller 102 and/or the one or more offboard controllers 124 may be coupled (e.g., physically, electrically, and/or communicatively) to one or more satellites 134. For example, the aircraft controller 102 and/or the one or more offboard controllers 124 may be coupled (e.g., physically, electrically, and/or communicatively) to one another via the one or more satellites 134. For instance, at least one component of the aircraft controller 102 may be configured to transmit data to and/or receive data from at least one component of the one or more offboard controllers 124, and vice versa. By way of another example, at least one component of the aircraft controller 102 may be configured to record event logs and may transmit the event logs to at least one component of the one or more offboard controllers 124, and vice versa. By way of another example, at least one component of the aircraft controller 102 may be configured to receive information and/or commands from the at least one component of the one or more offboard controllers 124, either in response to (or independent of) the transmitted event logs, and vice versa.

It is noted herein that the aircraft 100 and the components onboard the aircraft 100, the one or more offboard controllers 124, the one or more GPS satellites 122, and/or the one or more satellites 134 may be considered components of a system 138, for purposes of the present disclosure.

The one or more processors 104, 126 may include any one or more processing elements, micro-controllers, circuitry, field programmable gate array (FPGA) or other processing systems, and resident or external memory for storing data, executable code, and other information accessed or generated by the aircraft controller 102 and/or the one or more offboard controllers 124. In this sense, the one or more processors 104, 126 may include any microprocessor device configured to execute algorithms and/or program instructions. It is noted herein, however, that the one or more processors 104, 126 are not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., the memory), where the set of program instructions is configured to cause the one or more processors to carry out any of one or more process steps.

The memory 106, 128 may include any storage medium known in the art suitable for storing the set of program instructions executable by the associated one or more processors. For example, the memory 106, 128 may include a non-transitory memory medium. For instance, the memory 106, 128 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 106, 128 may be configured to provide display information to the display device (e.g., the one or more display devices 112). In addition, the memory 106, 128 may be configured to store user input information from a user input device of a user interface. The memory 106, 128 may be housed in a common controller housing with the one or more processors. The memory 106, 128 may, alternatively or in addition, be located remotely with respect to the spatial location of the processors and/or a controller. For instance, the one or more processors and/or the controller may access a remote memory (e.g., server), accessible through a network (e.g., internet, intranet, and the like).

The aircraft controller 102 and/or the one or more offboard controllers 124 may be configured to perform one or more process steps, as defined by the one or more sets of program instructions 108, 130. The one or more process steps may be performed iteratively, concurrently, and/or sequentially. The one or more sets of program instructions 108, 130 may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal component analysis (PCA), (multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions 108, 130 may be configured to operate via proportional control, feedback control, feedforward control, integral control, proportional-derivative (PD) control, proportional-integral (PI) control, proportional-integral-derivative (PID) control, or the like.

The one or more communication interfaces 110, 132 may be operatively configured to communicate with one or more components of the aircraft controller 102 and/or the one or more offboard controllers 124. For example, the one or more communication interfaces 110, 132 may also be coupled (e.g., physically, electrically, and/or communicatively) with the one or more processors 104, 126 to facilitate data transfer between components of the one or more components of the aircraft controller 102 and/or the one or more offboard controllers 124 and the one or more processors 104, 126. For instance, the one or more communication interfaces 110, 132 may be configured to retrieve data from the one or more processors 104, 126, or other devices, transmit data for storage in the memory 106, 128, retrieve data from storage in the memory 106, 128, or the like. By way of another example, the aircraft controller 102 and/or the one or more offboard controllers 124 may be configured to receive and/or acquire data or information from other systems or tools by a transmission medium that may include wireline and/or wireless portions. By way of another example, the aircraft controller 102 and/or the one or more offboard controllers 124 may be configured to transmit data or information (e.g., the output of one or more procedures of the inventive concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the aircraft controller 102 and/or the one or more offboard controllers 124 and the other subsystems (e.g., of the aircraft 100 and/or the system 138). In addition, the aircraft controller 102 and/or the one or more offboard controllers 124 may be configured to send data to external systems via a transmission medium (e.g., network connection).

The one or more display devices 112 may include any display device known in the art. For example, the display devices 112 may include, but are not limited to, one or more head-down displays (HDDs), one or more HUDs, one or more multi-function displays (MFDs), or the like. For instance, the display devices 112 may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, or the like. Those skilled in the art should recognize that a variety of display devices may be suitable for implementation in the present invention and the particular choice of display device may depend on a variety of factors, including, but not limited to, form factor, cost, and the like. In a general sense, any display device capable of integration with the user input device (e.g., touchscreen, bezel mounted interface, keyboard, mouse, trackpad, and the like) is suitable for implementation in the present invention.

The one or more user input devices 114 may include any user input device known in the art. For example, the user input device 114 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device, or the like. In the case of a touchscreen interface, those skilled in the art should recognize that a large number of touchscreen interfaces may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

In embodiments, the GUI 310 may be displayed on any computing device including a touchscreen (i.e., a touch-sensitive display surface capable of accepting directed control input provided by a user by making contact with a particular location relative to the display surface, e.g., by tapping, pressing for an extended length of time, or directing a finger or stylus along the surface of the screen in a predetermined path) and in communication with networks or controller devices/systems aboard the aircraft. For example, the GUI 310 may be displayed on a display 112 within a cockpit of the aircraft 100 as shown in FIG. 1B.

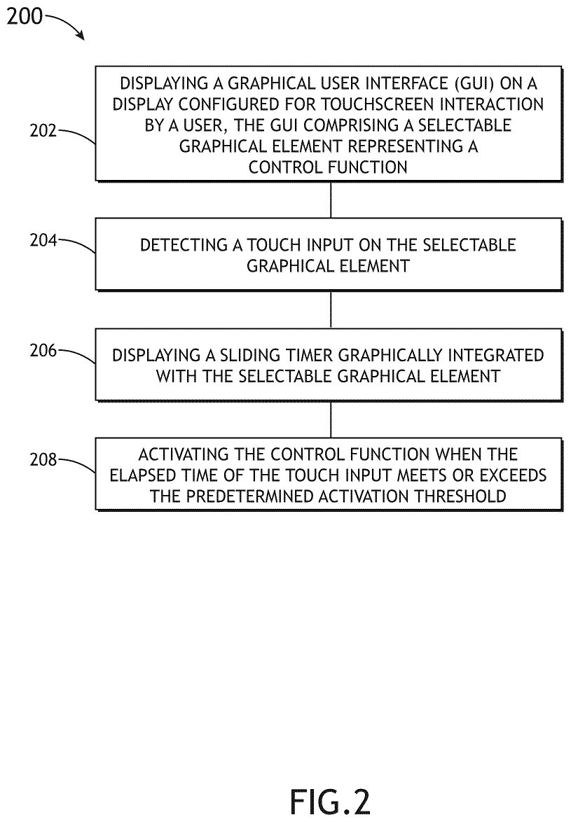

FIG. 2 illustrates a process flow diagram depicting a method 200, in accordance with one or more embodiments of the present disclosure. It is noted that the embodiments and enabling technologies described previously herein in the context of the system 138 should be interpreted to extend to the method 200. It is further noted herein that the steps of method 200 may be implemented all or in part by system 138. It is further recognized, however, that the method 200 is not limited to the system 138 in that additional or alternative system-level embodiments may carry out all or part of the steps of method 200.

At step 202, the GUI 310 is displayed. For example, the display 112 may display the GUI 310 to a user 308.

In embodiments, a selectable graphical element 300 representing a control function may be included in the GUI 310.

For example, in embodiments, the system 138 for controlling an aircraft 100 may include a display 112 configured for touchscreen interaction by a user 308. The system 138 may also include a controller 102 communicatively coupled to the display 112. The controller 102 may be configured to display the GUI 310. The controller 102 may include one or more processors 104 configured to execute a set of program instructions stored in a memory 106. The set of program instructions may be configured to cause the one or more processors 104 to display the GUI 310. The GUI 310 may include a selectable graphical element 300 representing a control function. The controller 102 may be configured to detect a touch input on the selectable graphical element 300. In response to detecting the touch input, the controller 102 may be configured to display a sliding timer 304 graphically integrated with the selectable graphical element 300. The sliding timer 304 may visually indicate an elapsed time of the touch input relative to a predetermined activation threshold. The control function may be activated when the elapsed time of the touch input meets or exceeds the predetermined activation threshold.

The control function may be any control function. The control function may correspond to an aircraft system or operation. For example, the control function represented by the selectable graphical element 300 in the GUI 310 may include a variety of operations relevant to aircraft control and management. These may involve functions such as adjusting the aircraft's altitude, setting the autopilot mode, managing the aircraft's lighting systems, or configuring communications systems. Additionally, the control function may relate to more operations like engine control, fuel management, or emergency systems activation. Each of these functions, when selected and held for the duration specified by the sliding timer 304, may be directed by the controller to be executed (e.g., a transmission sent to a sub-system of the aircraft) once the touch input's duration surpasses the predetermined activation threshold, ensuring deliberate and confirmed inputs by the user 308 in a high-stakes environment of an aircraft cockpit.

At step 204, a touch input on the selectable graphical element 300 may be detected. The detection of a touch input on the selectable graphical element 300 may encompass various sensing technologies integrated into the display 112. For instance, capacitive, or resistive touch technologies may be utilized to ascertain the presence and duration of a user's touch. The controller 102 may continuously monitor the touch-sensitive display 112 to identify when and where on the display a touch occurs, waiting for an interaction with the graphical element 300.

At step 206, a sliding timer 304 may be displayed. The sliding timer 304 may be graphically integrated with the selectable graphical element 300. The sliding timer 304 may be displayed in response to detecting the touch input and disappear when no touch is detected. Alternatively, the sliding timer 304 may be displayed even when no touch input is detected (e.g., at all times) with the selectable graphical element 300.

At an optional step, the sliding timer 304 may visually indicate an elapsed time of the touch input relative to a predetermined activation threshold. The visual changes in the sliding timer 304 may be designed to provide intuitive feedback to the user 308, indicating how close the touch duration is to reaching the predetermined activation threshold. This mechanism may ensure that the user is aware of the time remaining before the activation of the control function, potentially preventing premature or accidental activations.

At step 208, the control function may be activated when the elapsed time of the touch input meets or exceeds the predetermined activation threshold. For example, if the predetermined activation threshold is 5 seconds, then at 5 seconds of elapsed time the control function may be programmed to be activated. For example, a transmission may be sent out to perform some action or communication. For instance, the landing gear may be directed to be extended or the like.

FIG. 3 illustrates a time series set of views of a user input and of the GUI 310, in accordance with one or more embodiments of the present disclosure.

The sliding timer 304 may include a graphical ring 304 surrounding the selectable graphical element 300. The graphical ring 304 may be progressively filled or depleted to visually indicate the elapsed time of the touch input relative to the predetermined activation threshold.

The sliding timer 304 may include a straight graphical bar (not shown) positioned adjacent to (e.g., below or above) the selectable graphical element 300. The straight graphical bar may be progressively filled or depleted to visually indicate the elapsed time of the touch input relative to the predetermined activation threshold.

The GUI 310 may further include a numerical representation 302 positioned adjacent to the selectable graphical element 300. The numerical representation 302 may be configured to progressively count up or down to numerically indicate the elapsed time of the touch input relative to the predetermined activation threshold. For example, the numerical representation 302 may include a text of a number. For instance, the number may count down from 5 to 0 and activate the control function at 0. For instance, the number may count down from 3 to 0 and be activated at 0.

The controller 102 may be further configured to remove the numerical representation 302 from the GUI 310 when the touch input is discontinued before the elapsed time meets the predetermined activation threshold. The numerical representation 302 may, in some embodiments, only show while the user 308 is touching the selectable graphical element 300.

The controller 102 may be configured to change a color of the sliding timer 304 based on the elapsed time of the touch input to provide a visual indication of a remaining time until the control function is activated. For example, the color changes may mimic a stoplight. The change of the color of the sliding timer 304 may include the colors of red, intermediate color (e.g., yellow or orange), and green. For instance, the default color may be red and may change from red to yellow to green. For instance, the default color may be green and may change from green to yellow to red.

The display 112 may include (or be) an avionics display in an aircraft cockpit of an aircraft 100. Examples of avionics displays 112 are shown in FIG. 1B. The avionics displays 112 may be coupled to aircraft sensors 118 (e.g., radar) and aircraft sub-systems (e.g., landing gear sub-system). For instance, the control function may be an operation (e.g., deploying, retracting) of the landing gear sub-system.

The system 138 may include a vibrating mechanism 400 coupled to the display 112. The controller 102 may be further configured to provide a haptic feedback via the vibrating mechanism 400 based on the elapsed time of the touch input relative to the predetermined activation threshold. At least one of an intensity or a frequency of the haptic feedback may be progressively increased or decreased based on the elapsed time of the touch input relative to the predetermined activation threshold. For example, as the elapsed time passes, the controller 102 may be configured to increase the intensity (e.g., force of vibration via increased speed of a motor 400) and to increase the frequency (e.g., decreasing pauses between haptic feedback vibration pulses). This may give the user 308 a relatively clear indication and feel, without even needing to look, on how much elapsed time has passed.

Embodiments herein may provide alternative systems and methods for providing feedback to pilots when interacting with touch display widgets to activate specific functionalities. Embodiments may serve as a mechanism to prevent unintended activation of features by requiring a pilot to engage with the display for a specified duration, thereby confirming the intended operation. Further, combinations of other feedback mechanisms may improve the pilot's understanding of the timing of the functions, such as increasing haptic feedback frequencies and intensity, changing colors over time, and numerical representations. The combination may provide surety of feedback not necessarily achievable by a single feedback mechanism alone.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

1. A system for controlling an aircraft, the system comprising:
a display configured for touchscreen interaction by a user;
a vibrating mechanism coupled to the display; and
a controller communicatively coupled to the display and configured to display a graphical user interface (GUI), wherein the controller comprises one or more processors configured to execute a set of program instructions stored in a memory, the set of program instructions configured to cause the one or more processors to:
display the GUI comprising a selectable graphical element representing a control function,
detect a touch input on the selectable graphical element;
display a sliding timer graphically integrated with the selectable graphical element, wherein the sliding timer visually indicates an elapsed time of the touch input relative to a predetermined activation threshold;
provide a haptic feedback via the vibrating mechanism based on the elapsed time of the touch input relative to the predetermined activation threshold, wherein at least one of an intensity or a frequency of the haptic feedback is progressively increased or decreased based on the elapsed time of the touch input relative to the predetermined activation threshold; and
activate the control function when the elapsed time of the touch input meets or exceeds the predetermined activation threshold.

2. The system of claim 1, wherein the sliding timer comprises a graphical ring surrounding the selectable graphical element, and wherein the graphical ring is progressively filled or depleted to visually indicate the elapsed time of the touch input relative to the predetermined activation threshold.

3. The system of claim 1, wherein the sliding timer comprises a straight graphical bar positioned adjacent to the selectable graphical element, and wherein the straight graphical bar is progressively filled or depleted to visually indicate the elapsed time of the touch input relative to the predetermined activation threshold.

4. The system of claim 1, wherein the GUI further comprises a numerical representation positioned adjacent to the selectable graphical element, wherein the numerical representation is configured to progressively count up or down to numerically indicate the elapsed time of the touch input relative to the predetermined activation threshold.

5. The system of claim 4, wherein the controller is further configured to remove the numerical representation from the GUI when the touch input is discontinued before the elapsed time meets the predetermined activation threshold.

6. The system of claim 1, wherein the controller is configured to change a color of the sliding timer based on the elapsed time of the touch input to provide a visual indication of a remaining time until the control function is activated.

7. The system of claim 6, wherein the change of the color of the sliding timer comprises the colors of red, orange, and green.

8. The system of claim 1, wherein the display comprises an avionics display in an aircraft cockpit of an aircraft, and wherein the control function corresponds to an aircraft system or operation.

9.-10. (canceled)

11. A method for controlling an aircraft, the method comprising:
displaying a graphical user interface (GUI) on a display configured for touchscreen interaction by a user, the GUI comprising a selectable graphical element representing a control function;
detecting a touch input on the selectable graphical element;
displaying a sliding timer graphically integrated with the selectable graphical element, wherein the sliding timer visually indicates an elapsed time of the touch input relative to a predetermined activation threshold;
providing a haptic feedback via a vibrating mechanism based on the elapsed time of the touch input relative to the predetermined activation threshold, wherein at least one of an intensity or a frequency of the haptic feedback is progressively increased or decreased based on the elapsed time of the touch input relative to the predetermined activation threshold; and
activating the control function when the elapsed time of the touch input meets or exceeds the predetermined activation threshold.

12. The method of claim 11, wherein the sliding timer comprises a graphical ring surrounding the selectable graphical element, and wherein the graphical ring is progressively filled or depleted to visually indicate the elapsed time of the touch input relative to the predetermined activation threshold.

13. The method of claim 11, wherein the sliding timer comprises a straight graphical bar positioned adjacent to the selectable graphical element, and wherein the straight graphical bar is progressively filled or depleted to visually indicate the elapsed time of the touch input relative to the predetermined activation threshold.

14. The method of claim 11, further comprising displaying a numerical representation positioned adjacent to the selectable graphical element, wherein the numerical representation is configured to progressively count up or down to numerically indicate the elapsed time of the touch input relative to the predetermined activation threshold.

15. The method of claim 14, further comprising removing the numerical representation from the GUI when the touch input is discontinued before the elapsed time meets the predetermined activation threshold.

16. The method of claim 11, changing a color of the sliding timer based on the elapsed time of the touch input to provide a visual indication of a remaining time until the control function is activated.

17. The method of claim 16, wherein the changing of the color of the sliding timer comprises the colors of red, orange, and green.

18. The method of claim 11, wherein the display comprises an avionics display in an aircraft cockpit of an aircraft, and wherein the control function corresponds to an aircraft system or operation.

19.-20. (canceled)
